(19) United States
(12) Patent Application Publication
(10) Pub. No.: US 2026/0183723 A1
(43) Pub. Date: Jul. 2, 2026

(54) METHODS OF MAKING LITHIUM SELECTIVE NANOFILTRATION MEMBRANES AND THEIR APPLICATIONS

(71) Applicant: Greenvi Corp., Edmonton (CA)

(72) Inventors: Ahmad Rahimpour, Edmonton (CA); Mohtada Sadrzadeh, Edmonton (CA); Amir Aghaei, Edmonton (CA); Sadegh Aghapour Aktij, Edmonton (CA)

(21) Appl. No.: 19/008,345

(22) Filed: Jan. 2, 2025

(51) Int. Cl. B01D 71/68; B01D 61/02; B01D 67/00; B01D 69/12; B01D 71/56

(52) U.S. Cl. CPC B01D 71/68; B01D 61/027; B01D 67/00113; B01D 67/0013; B01D 67/0083; B01D 67/00933; B01D 69/1251; B01D 71/56; B01D 2311/2649; B01D 2323/081; B01D 2323/216; B01D 2323/21826; B01D 2323/2185; B01D 2323/219; B01D 2325/04

(57) ABSTRACT

A method of making high-performance thin-film composite (TFC) nanofiltration (NF) membrane, comprising a polysulfone (PSf) or polyethersulfone (PES) support membrane layer and a selective layer that comprises a modified polypiprazine-amide nanofiltration (NF) membrane for separation of lithium from magnesium/lithium and brine solution. The method comprising: i) preparing a polysulfone (PSf) or polyethersulfone (PES) support membrane by using a non-solvent induced phase separation (NIPS) technique; (ii) contacting the formed support membrane with an aqueous diamine solution comprising 0.1-3% w/v piperazine, and 0.5-2.0% w/v NaOH, for a time period of 60-120 seconds; (iii) removing excess aqueous diamine solution from the support surface; (iv) gently pouring an organic solution containing 0.15% w/v TMC on the support surface and initiating an interfacial polymerization (IP) reaction; (v) draining the organic solution from the support surface and heat-curing the formed thin film composite (TFC) at about 80° C. for about 5 minutes; and (vi) washing the final thin-film composite (TFC) nanofiltration (NF) membrane.

### TECHNICAL FIELD

The present disclosure relates to the field of membrane technology, specifically thin film composite (TFC) Nanofiltration (NF) membranes. More specifically, the disclosure pertains to fabricating novel polypiprazine-amide NF membranes through interfacial polymerization (IP), coupled with a post-treatment process, designed for highly efficient separation of lithium from magnesium/lithium and lake brine solutions.

### BACKGROUND

The following paragraphs are not an admission that anything discussed in them is prior art or part of the knowledge of persons skilled in the art.

Lithium is vital in the global market, playing a key role in advancing technologies for transitioning to cleaner and more sustainable energy solutions. Its significance is evident in the dominance of lithium-ion batteries, powering electric vehicles, renewable energy storage, and consumer electronics, underlining its indispensable role in modern technology. The increasing demand across these sectors emphasizes the critical need for efficient extraction and recovery methods.

The primary challenge in Lithium-ion (Li⁺) recovery from brines is the presence of various other cations, including sodium (Na⁺), potassium (K⁺), magnesium (Mg²⁺), and calcium (Ca²⁺). Notably, Mg²⁺ and (lithium) Li⁺ share similar chemical properties and possess closely matched hydration radii (Mg²⁺: 0.43 nm, Li⁺: 0.38 nm). Consequently, separating Mg²⁺ and Li⁺ ions becomes challenging, particularly when dealing with high Mg²⁺/Li⁺ ratios. Conventional methods for lithium extraction from brine solutions involve large evaporation ponds, exposing lithium-rich brine to the elements, electrochemical intercalation-deintercalation (EID), and direct lithium extraction (DLE) methods like adsorption and ion exchange, which confront significant challenges, including environmental impact, suboptimal extraction efficiency, and high energy consumption. Innovative solutions like TFC NF membranes are emerging to address these issues and pave the way for a more sustainable and efficient lithium extraction process. These membrane technologies offer precise and selective separation of lithium ions from brine, ensuring a higher-purity lithium stream compared to conventional methods. Their efficiency in lithium recovery is notably superior, optimizing resource utilization and reducing operational costs and ecological footprint. However, current commercial TFC NF membranes, such as NF 90 and NF 270 (DuPont FilmTec), and Desal-5 (GE Osmonics), have limitations, including limited selectivity leading to impurity co-extraction and membrane fouling issues, impacting longevity and effectiveness. Addressing these limitations is imperative for developing new and innovative TFC NF membranes, promising enhanced efficiency, selectivity, and sustainability in lithium recovery from brine, ensuring a balance between technological progress and environmental responsibility.

Most research on positively charged NF membranes has primarily utilized polyethyleneimine (PEI) with a high amino density in the aqueous phase monomer or has coated PEI on the surface of negatively charged NF membranes to modify their charge characteristics. However, the substantial molecular volume and uneven stacking of PEI would result in non-uniform polymerization on the membrane surface. Furthermore, the linear aliphatic structure of PEI increases the close packing of the resulting polyamide chains, reducing the available free volume and significantly diminishing water permeability. Moreover, the permeability-selectivity trade-off inherent in TFC polypiprazine-amide NF membranes constrains their performance in practical applications for Mg²⁺/Li⁺ separation due to the highly negatively charged surface. Therefore, to overcome the challenges associated with PEI and limitations of low Mg²⁺/Li⁺ selectivity of conventional TFC NF membranes, the development of a strategy for the surface modification of TFC NF membranes through chemical grafting is essential, leading to improve the membrane performance for efficient lithium extraction from brine. Modifying the membrane surface with amine-containing monomers introduces a more positive charge or reduces the deprotonation capability of carboxyl groups (COOH), thereby exhibiting elevated rejection of divalent cations such as Mg²⁺ over Li⁺. The applicants have developed innovative TFC polypiprazine-amide NF membranes through the IP reaction followed by facile surface grafting. The IP method is commonly used to fabricate TFC NF membranes, which involves the polymerization of two immiscible organic phase and aqueous phase monomers on a porous substrate having a nonwoven layer. The microporous support layer merely supports the membrane during fabrication, handling, and operation at high pressures, while the ultrathin selective layer separates water molecules from salt molecules. The primary function of the woven/nonwoven layer is to support and increase the mechanical strength of the TFC membranes. L-arginine (ARG) (Formula I) and L-histidine (Formula II) monomers, recognized as an amine-containing hydrophilic biomaterial with flexible main structures, and 2,4,6-Triaminopyrimidine (TAP) as amine-containing hydrophilic material were used to modify the structure and improve the performance of TFC polypiprazine-amide NF membrane through surface grafting for Lithium extraction from brines.

ARG is crucial in constructing aquaporins (AQPs) within the human body. AQPs are transmembrane proteins with an hourglass-like inner structure, serving as water channels. In particular, ARG contributes to creating the narrowest segment of the AQP channel. The strong hydrogen bond interaction between ARG and water enhances the rapid transport of water through AQPs. Grafted ARG on the surface of TFC NF membranes increases the positive charges of the surfaces which are responsible for repelling divalent cations like Mg²⁺. Inspired by ARG's hydrophilic and positively charged effect, we employed ARG to modify the polypiprazine-amide selective layer to separate Mg²⁺ and Li⁺ through facile grafting effectively. During this process, the active amine groups in ARG readily interact with the unreacted acyl chloride groups of trimesoyl chloride (TMC) and crosslink with glutaraldehyde (GLA), increasing positive surface charge and hydrophilic properties of the polypiprazine-amide selective layer, which are two major parameters in TFC NF membranes for delivering high water permeability and Mg²⁺/Li⁺ selectivity.

L-histidine offers a multifaceted approach to modifying NF membranes for the selective separation of lithium ions. Its amphiprotic nature, containing both acidic and basic functional groups, facilitates pH-dependent charge modification on membrane surfaces. With a pKa around 6.0, the imidazole group in L-histidine allows for positive charge introduction onto the membrane surface at neutral pH, which is crucial for lithium separation conditions. Additionally, its biocompatibility ensures suitability for applications involving contact with biological systems. L-histidine can be easily incorporated into membrane materials or coated onto surfaces through various techniques. Importantly, its selective binding affinity for certain metal ions, including lithium, enhances the membrane's ability to selectively separate lithium ions from other species in the feed solution. These properties collectively make L-histidine a promising candidate for modifying NF membranes to improve their positive charge and enhance lithium-ion separation efficiency.

TAP presents an ideal candidate for modifying NF membranes to enhance their positive charge for selective separation of lithium ions due to its polyfunctional structure, comprising multiple amino groups that can be protonated to induce positive charges on the membrane surface. With a high charge density stemming from its three amino groups, TAP offers substantial electrostatic interactions with lithium ions, facilitating their selective separation. Moreover, TAP's variable pKa values enable pH-dependent control over membrane surface charge, optimizing conditions for lithium-ion separation. Its chemical stability ensures long-term membrane performance, while its selective affinity for lithium ions enhances specificity in separation processes. TAP's compatibility with membrane materials further underscores its suitability for membrane modification, promising improved efficiency in lithium-ion separation applications.

Chemical crosslinking of ARG, L-histidine, and TAP with GLA is employed to modify the surface of NF membranes, enhancing their positive charge for selective lithium ion separation. GLA serves as a crosslinking agent, facilitating the covalent attachment of these amino acids onto the membrane surface.

To achieve the optimal membrane structure, the effects of piperazine (PIP), ARG, and GLA concentrations on the structure of the selective PA layer were investigated, and the membrane performance was evaluated using various Mg²⁺/Li⁺ ratios in the feed solution. Our crosslinked NF membranes indicated selective retention of divalent ions, notably magnesium ions (Mg²⁺), enabling the efficient removal of Mg ions, a significant challenge in lithium extraction, thereby enhancing the overall purity of the recovered lithium. For example, the membrane modified with ARG showed outstanding performance when tested in a simulated brine solution with a total concentration of 25000 ppm, including different salts like LiCl, MgCl₂, and CaCl₂. It displayed a remarkable selectivity of approximately 20 for Mg²⁺ over Li⁺ ions and a noteworthy water permeability of about 9 L·m⁻²·h⁻¹·bar⁻¹ (LMH/bar).

The membranes developed according to the described method offer exceptionally high water transport rates while maintaining a superior level of divalent ion (Mg²⁺) rejection compared to monovalent ion (Li⁺). As a result, these membranes demonstrate resistance to fouling and harsh feed and operating conditions. Notably, they exhibit a synergistic increase in water permeability (approximately 6-10 LMH/bar), Mg²⁺ ion rejection (80-95%), and antifouling properties. The process of fabricating these novel membrane materials is straightforward, cost-effective, and conducive to large-scale production. Utilizing affordable and readily accessible materials in constructing TFC NF membranes, coupled with their impressive performance in handling concentrated brines, underscores their significant potential for commercial utilization.

The intended disclosure covers the complete process of making novel NF membranes that overcome the various drawbacks of the prior art. The process includes i) the continuous process of fabrication of porous polyethersulfone (PES) substrate, ii) the fabrication process of polypiprazine-amide selective layer, and iii) the modification process of selective layer with cheap chemical comprising multiple amino functional groups followed by chemical crosslinking.

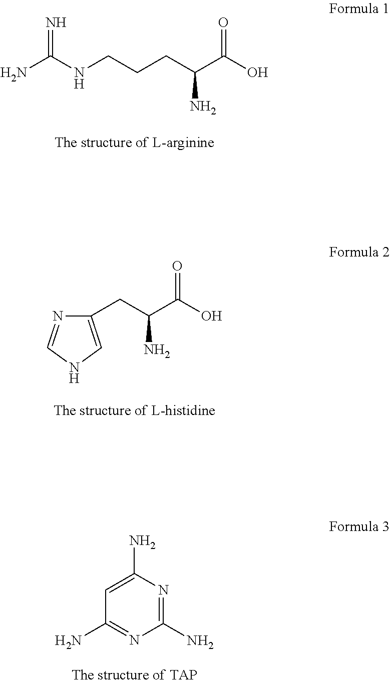 [SMILES: N=C(N)NCCC[C@H](N)C(=O)O ; N[C@@H](Cc1c[nH]cn1)C(=O)O ; Nc1cc(N)nc(N)n1]

### SUMMARY

The objectives of the disclosure revolve around addressing the critical challenges in lithium-ion recovery from brines, driven by the increasing demand for lithium in various industries. The primary challenge lies in separating lithium ions from other cations present in brines, especially magnesium ions, due to their similar chemical properties. Therefore, the disclosure aims to develop innovative TFC nanofiltration membranes that offer precise lithium-ion separation, high-purity lithium recovery, and resistance to fouling. By modifying membrane surfaces with amino-containing monomers like ARG, L-histidine, and TAP, the disclosure seeks to enhance membrane performance for efficient lithium extraction from brines. Through chemical grafting and crosslinking with GLA, the goal is to increase membrane selectivity, water permeability, and resistance to fouling, thereby optimizing lithium recovery processes. The disclosure further aims to overcome the limitations of current NF membranes by utilizing innovative modification techniques. Unlike conventional approaches using PEI, which suffers from non-uniform polymerization and reduced water permeability, the disclosure focuses on surface modification through chemical grafting for enhanced performance. By incorporating amino-containing monomers like ARG and L-histidine, the disclosure also seeks to introduce a more positive charge to the membrane surface, improving selectivity for lithium ions over magnesium ions. This modification strategy, coupled with chemical crosslinking with GLA, aims to optimize membrane properties for efficient lithium extraction while ensuring cost-effectiveness and scalability. Overall, the disclosure aims to revolutionize lithium recovery processes by providing innovative TFC NF membranes with superior performance, paving the way for sustainable and efficient lithium extraction from brines.

This disclosure for lithium-selective membranes introduces an innovative approach to lithium extraction from brines, addressing critical challenges inherent in current methods. These membranes feature a three-layer structure: (i) a top thin crosslinked layer of ARG, L-histidine and TAP with GLA, (ii) intermediate polypiprazine-amide layer prepared via IP and modified with amine-containing hydrophilic biomaterials such as ARG, L-histidine, and (iii) a bottom microporous sublayer with diverse structures and materials fabricated through non-solvent induced phase separation (NIPS). At the heart of this innovation lies the surface modification with chemicals containing amine functional groups such as ARG, L-histidine, and TAP, which enhance the selectivity and efficiency of TFC membranes in lithium ion separation. By precisely tailoring this layer, the membranes achieve targeted separation capabilities and antifouling properties crucial for efficient lithium extraction. The polyamide selective layer is synthesized via IP reaction between diamine monomer (0.1-3.0 w/w % PIP in the presence of hydrophilic additives) and TMC (0.05-0.2% w/v %) in hexane. The polyfunctional acyl halides and diamines undergo a condensation reaction initiated by placing the reactants in two separate phases that do not mix. Polymerization occurs at the interface of these two phases, situated atop the porous support membrane. This step is crucial for imparting the membrane with its selective separation capabilities, allowing for the efficient retention of lithium ions while rejecting other unwanted ions present in the brine. Additionally, incorporating surface modification with amine-containing chemicals further enhances the membrane's selectivity by introducing additional functional groups capable of interacting with magnesium and lithium ions.

The support membranes, preferably prepared with PES as the main polymer, polyvinylpyrrolidone, and acetic acid as additives, and DMF or DMAc as solvents, were fabricated via NIPS. A polyester nonwoven fabric was incorporated into the final membranes to improve mechanical strength and ease of handling.

In the present disclosure, modified TFC NF membranes were developed to achieve superior water permeability and Mg/Li ions selectivity. The method briefly includes:
(i) Providing roll-to-roll flat sheet PES porous support using NIPS method.
(ii) Forming TFC polypiprazine-amide membranes on the surface of porous PES supports using IP reaction of amine monomer (PIP) and acid chloride monomer (TMC). This involves contacting the porous substrate with an aqueous PIP monomer solution and a TMC organic monomer solution to create a selective layer.
(iii) Providing modified TFC polypiprazine-amide membranes by coating amine-containing materials followed by crosslinking with GLA.

As another example, the TFC membrane modified with 2.0 wt % ARG and 0.3 wt % GA, demonstrated a lithium-ion rejection of −115.6% and magnesium ion rejection of 91.0%, while the water permeability was 9.8 LMH/bar during filtration of a mixed solution of 2000 ppm LiCl and MgCl₂ (Mg²⁺/Li⁺ ratio of 20).

According to embodiments of the disclosure, the lithium-selective nanofiltration membranes offer numerous applications, including efficiently separating lithium ions from brine solutions, desalination processes to selectively remove lithium ions from seawater or other lithium-rich water sources, treating industrial wastewater containing lithium contaminants, facilitating the recovery and recycling of lithium while minimizing environmental pollution and recycling of lithium-ion batteries by selectively separating lithium ions from battery waste streams.

A method of making a high-performance thin-film composite (TFC) nanofiltration (NF) membrane, the method comprising: (i) preparing a polysulfone (PSf) or polyethersulfone (PES) support membrane by using a non-solvent induced phase separation (NIPS) technique: (a) dissolving PSf or PES polymer in one or more solvents so as to form a uniform solution; (b) maintaining a concentration of polyvinylpyrrolidone in the uniform solution, for example at a range of 1.0-5.0 wt %; (c) maintaining a concentration of polyethylene glycol in the uniform solution, for example at a range of 2.0-10.0 wt %; (d) maintaining a concentration of acrylic acid in the uniform solution, for example at a range of 2.0-10.0 wt %; (e) maintaining a concentration of surfactant in the uniform solution, for example at a range of 2.0-10.0 wt %; (f) degassing the solution, and thereafter casting the solution on a 100-micron thick nonwoven polyester support at a cast thickness, for example at about 0.10-0.12 mm to form a cast film; (g) immediately immersing the cast film in a water precipitation bath and initiating phase separation; (h) removing the solvents, and then treating the formed support membrane with a solution; (ii) contacting the formed support membrane with an aqueous diamine solution, for example comprising 0.1-3% w/v piperazine, and for example 0.5-2.0% w/v NaOH, for a time period of 60-120 seconds in one example; (iii) removing excess aqueous diamine solution from the support surface; (iv) gently pouring an organic solution, for example containing 0.15% w/v TMC on the support surface and initiating an interfacial polymerization (IP) reaction; (v) draining the organic solution from the support surface and heat-curing the formed thin film composite (TFC), for example at about 80° C. for about 5 minutes; and (vi) washing the final thin-film composite (TFC) nanofiltration (NF) membrane.

A high-performance thin-film composite (TFC) nanofiltration (NF) membrane, comprising: a polysulfone (PSf) or polyethersulfone (PES) support membrane layer; and a selective layer that comprises a modified polypiprazine-amide nanofiltration (NF) membrane for separation of lithium from magnesium/lithium and brine solution.

In various embodiments, there may be included any one or more of the following features: Step (i)(a) comprises dissolving 14-16% PSf or PES in the one or more solvents so as to form the uniform solution. The one or more solvents comprises one or more of N-methyl-2-pyrrolidone, dimethylformamide (DMF), and dimethylacetamide (DMAc). The one or more solvents comprises dimethylformamide (DMF), and step (i)(a) is done at 60° C. under constant stirring at 500 rpm for 4-6 hrs. In step (i)(e) the surfactant comprises one or more of sodium dodecyl sulfate or Triton X-100 (C14H22O(C2H4O)n). In step (i)(c), casting the solution on is done at a casting speed of 1-2 m/min, using a semi-automated continuous membrane casting unit; and in step (i)(g), the water precipitation bath is at 20-30 degrees Celsius. The solution in step (i)(h) contains one or more of glycerol, ethanol, or hexane, either individually, or sequentially, for 10-15 minutes. In step (ii), the aqueous diamine solution comprises 0.5-2% w/v L-arginine (ARG) and L-histidine. Step (iv) is carried out over 30-90 seconds. After step (vi): (vi)(1) applying a solution of 0.5-2 wt. % of L-arginine (ARG), L-histidine, or TAP onto the thin-film composite (TFC) nanofiltration (NF) membrane to ensure complete saturation of the membrane. (V)(2), pouring an aqueous solutions containing 0.1-0.5 glutaraldehyde onto the surface of L-arginine (ARG), L-histidine, or TAP saturated thin-film composite (TFC) nanofiltration (NF) membrane and allowing to sit for a sufficient time to facilitate crosslinking. (V)(3) heat-treating the thin-film composite (TFC) nanofiltration (NF) membrane. The high-performance thin-film composite (TFC) nanofiltration (NF) membrane structured to achieve a flux of 6-10 LMH/bar and demonstrate a magnesium ion rejection rate of at least 85% when filtering aqueous salt solutions containing 2000-5000 ppm of MgCl₂ at 70 psi and 25° C. The high-performance thin-film composite (TFC) nanofiltration (NF) membrane structured to filter a mixed salt solution (2000 ppm, Mg²⁺/Li⁺ ratio of 20:1) with Mg²⁺ rejection increased substantially from 34-36% to 93-95%, while Li⁺ exhibited negative rejections, ranging from −6% to −169%. The high-performance thin-film composite (TFC) nanofiltration (NF) membrane structured to filter a mixed salt solution (2000 ppm, Mg²⁺/Li⁺ ratio of 20:1) and reject at least 88% and −42%, of Mg2+ and Li+, respectively, with an average flux of at least 45-50 LMH. The high-performance thin-film composite (TFC) nanofiltration (NF) membrane, with a GLA concentration of 0.3 wt % and L-arginine (ARG) of 2 wt %, structured to filter a mixed salt solution (2000 ppm and Mg2+/Li+ ratio of 20:1, at 70 psi and 25° C.), and reject at least 91% of Mg2+, and −115% of Li+, with water flux of at least 47 LMH in the mixed solution. The high-performance thin-film composite (TFC) nanofiltration (NF) membrane structured to maintain stable water flux and salt rejection performance over 24 hours of filtration in solutions containing 1000 ppm of LiCl or MgCl₂. The high-performance thin-film composite (TFC) nanofiltration (NF) membrane structured to, when filtering brine (1000 ppm) at 70 psi: reject at least 20%, 20%, and 19% for the monovalent salts LiCl, NaCl, and KCl, respectively; reject at least 88% for MgCl₂, at least 71% for CaCl₂), at least 85% for Na₂SO₄, and at least 91% for MgSO₄; demonstrate at least water fluxes of 58, 58, and 62 LMH for monovalent cations, such as LiCl, NaCl, and KCl, respectively; and demonstrate at least fluxes of 53, 48, 56, and 54 LMH, of MgCl₂, CaCl₂), Na₂SO₄, and MgSO₄, respectively. The high-performance thin-film composite (TFC) nanofiltration (NF) membrane structured to, when filtering brine (21000 ppm) at 70 psi: demonstrate water permeability (at least 18.6 LMH); reject Mg²⁺ (at least 90%) and Ca²⁺ (at least 75%); allow the passage of Li⁺, Na⁺, and K⁺ with rejections of at most 10%, 13%, and 13%, respectively. The high-performance thin-film composite (TFC) nanofiltration (NF) membrane structured to, when filtering brine (22000 ppm) at 220 psi and 25° C.: achieve an initial water flux of at least 32.4 LMH, with a decrease of at most to 30.3 LMH after 24 hours, with Li⁺, Mg²⁺, and Ca²⁺ rejections dropping at most from −73%, 86%, and 60% to at least −72%, 81%, and 53%, respectively, over the same period.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of a system for fabricating a flat sheet PES membrane as a substrate for a TFC NF membrane.

FIGS. 2A and 2B are scanning electron microscopy (SEM) photographs showing the surface and the cross-section of the sample PES support membrane, respectively.

FIGS. 3A and 3B are scanning electron microscopy (SEM) and transmission electron microscopy (TEM) photographs, respectively, of the TFC NF membrane that shows a thin selective layer of polymer (50-100 nm) is formed on the support membrane.

FIGS. 4A and 4B are graphical representations illustrating the effect of PIP concentrations (0.1, 0.5, 1, 2, and 3 wt %) on the performance of NF membranes illustrating single-salt solutions containing 1000 ppm of LiCl or MgCl₂ and mixed salt solution containing 2000 ppm LiCl or MgCl₂ with Mg²⁺/Li⁺ ratio of 20:1, respectively. The membranes were tested at 70 psi and 25 degrees Celsius.

FIGS. 5A and 5B are graphical representations illustrating the effect of ARG concentration on membrane performance in single-salt solutions containing 1000 ppm of LiCl or MgCl₂ and mixed solution with a total concentration of 2000 ppm and Mg²⁺/Li⁺ ratio of 20:1 (70 psi and 25 degrees celsius), respectively. GLA concentration in the coating layer was 0.1 wt %.

FIG. 6 is a graphical representation illustrating the performance of the modified membranes with ARG, L-histidine, and TAP. The concentration of monomers in the coating solution was 2 wt %. Mixed solution of MgCl₂ and LiCl with total concentration of 2000 ppm and Mg²⁺/Li⁺ ratio of 20:1 was used.

FIGS. 7A and 7B are graphical representations illustrating the effect of GLA concentration on membrane performance in single-salt solutions containing 1000 ppm of LiCl or MgCl₂ and mixed solution with a total concentration of 2000 ppm and Mg²⁺/Li⁺ ratio of 20:1 (70 psi and 25 degrees celsius), respectively. The ARG concentration in the coating layer was 2 wt %.

FIGS. 8A-8D are graphical representations illustrating the effect of LiCl and MgCl₂ concentration on the performance of A2-G-0.3 membrane, the stability of A2-G-0.3 membrane in a solution containing 1000 ppm LiCl and MgCl₂, the effect of Mg²⁺/Li⁺ ratio with a total concentration of 2000 ppm on the performance of A2-G-0.3 membrane, and the performance of A2-G0.3 membrane in filtering various inorganic salts, each containing 1000 ppm of LiCl, NaCl, KCl, MgCl₂, CaCl₂, Na₂SO₄, and MgSO₄, respectively. All filtration tests were conducted at 25 degrees celsius and 70 psi.

FIGS. 9A and 9B are graphical representations illustrating the low-pressure NF performance of simulated brine with a total salt concentration of 21000 ppm, including Li⁺ (74 ppm), Na⁺ (4767 ppm), K⁺ (1522 ppm), Mg²⁺ (1496 ppm), Ca²⁺ (69 ppm), and Cl⁻ (13,595 ppm) ions. This brine was simulated based on the composition of the Clayton Valley and Smackover brines in the United States. The filtration tests were conducted at 25 degrees Celsius and 70 psi.

FIGS. 10A and 10B are graphical representations illustrating the high-pressure NF performance of simulated brine with a total salt concentration of 22000 ppm, including Li⁺ (187 ppm), SO₄²⁻ (510 ppm), Mg²⁺ (5236 ppm), Ca²⁺ (41 ppm), and Cl⁻ (16113 ppm) ions. This brine was simulated based on the composition of the pretreated brine sourced from Qinghai, China. The filtration tests were conducted at 25 degrees Celsius and 225 psi.

### DETAILED DESCRIPTION

Immaterial modifications may be made to the embodiments described here without departing from what is covered by the claims.

In this document, various methods of making a high-performance thin-film composite (TFC) nanofiltration (NF) membrane are disclosed. The methods comprise, in an initial stage, preparing a polysulfone (PSf) or polyethersulfone (PES) support membrane by using a non-solvent induced phase separation (NIPS) technique.

Fabrication and characterization of lithium selective NF membranes according to the disclosure.

Piperazine (PIP, ≥99%), trimesoyl chloride (TMC, 98%), n-Hexane (≥99%), and glutaraldehyde (GLA, 50 wt % in water) were sourced from Sigma Aldrich. ARG monohydrochloride (ARG, ≥98%), L-histidine and TAP were purchased from Sigma-Aldrich. The salts used to evaluate the membrane performance, including lithium chloride (LiCl, ≥99%), sodium chloride (NaCl, ≥99%), potassium chloride (KCl, ≥99%), magnesium chloride hexahydrate (MgCl₂·6H₂O, ≥99%), calcium chloride (CaCl₂, ≥99%) sodium sulfate (Na₂SO₄, ≥99%), and magnesium sulfate (MgSO₄, 99%) were all purchased from Fisher Scientific.

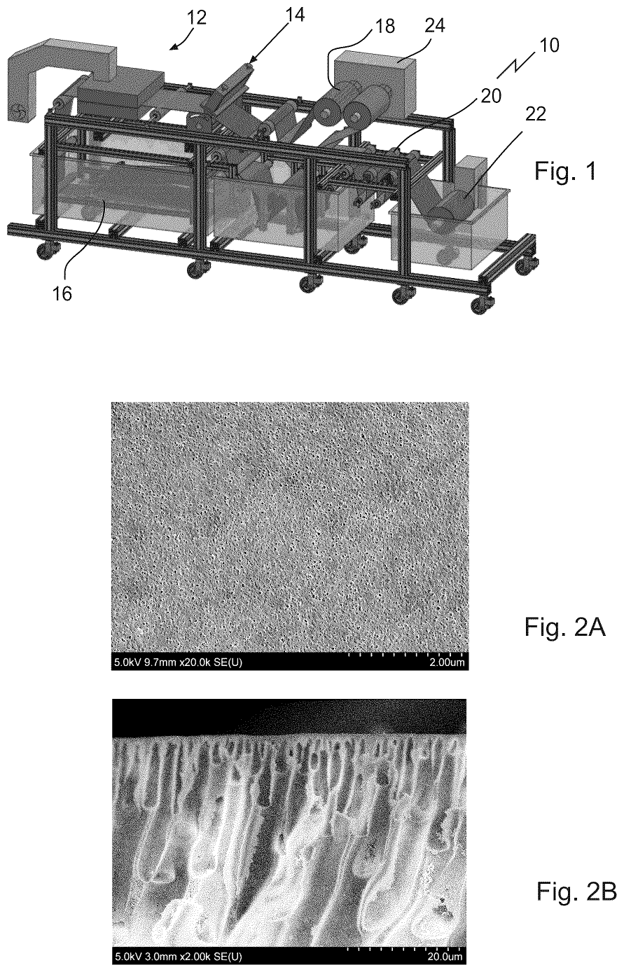

To initiate the production of lithium-selective membranes, the initial step involves making a PES porous support membrane with an approximate thickness of 50 microns on a nonwoven polyester fabric, which typically has a thickness of 100 microns. This process is carried out utilizing a semi-automated casting machine, as illustrated in FIG. 1, which provides various benefits, including superior membrane formability and flexibility, improved structural integrity, and adequate hydrophobicity to the formation of a thin polyamide layer on the support. The PES porous support membrane is fabricated using the NIPS method, a technique known for its effectiveness in creating porous membranes in which a uniform polymer solution is cast onto a substrate, and immersion in a nonsolvent bath induces phase separation. This method involves a scale of operation spanning 300 mm in width and 20 m in length, with a production rate ranging from 0.5 to 2 meters per minute.

TFC polypiprazine-amide membranes with a selective layer approximately 100 nm thick are subsequently produced on the PES porous support membrane through in-situ IP. This process involves immersing the membrane in a aqueous solution containing diamine (PIP) in water with NaOH, surfactants (SDS or Triton X-100), and/or ARG and L-histidine, and then organic solution containing TMC in hexane. The membrane is then subjected to heat curing at 80° C. for 3-5 minutes.

In order to enhance the magnesium rejection over lithium in TFC NF membranes, we functionalized the surface of as-prepared TFC polypiprazine-amide membranes by coating amine-containing materials such as ARG, L-histidine, and TAP followed by crosslinking with GLA. By introducing the amine functionalities of these chemicals onto the membrane surface, we improved the retention of magnesium ions remarkably while letting lithium ions pass through the membrane. Incorporating ARG and L-histidine, known for their affinity towards divalent cations like magnesium, facilitated stronger interactions between the membrane surface and magnesium ions, consequently enhancing their rejection during filtration processes.

Morphological investigations of the TFC NF membranes were carried out using microscopic analyses, including Field Emission Scanning Electron Microscopy (FESEM) with a Zeiss Sigma 300 VP instrument and Transmission Electron Microscopy (TEM) using a Philips/FEI Morgagni 268 device. The surface charge of the fabricated membranes was assessed using a Surpass™ 3 Electrokinetic analyzer from Anton, Austria, which measures the zeta potential of the membranes over a pH range from 4 to 9 in a 1 mM KCl solution. Water contact angles (WCA) were determined using the sessile drop method with a contact angle analyzer from KRUSS GmbH, Germany.

The flux and rejection of the fabricated TFC NF membranes were assessed in a lab-scale NF and RO cross-flow filtration systems at 25 degrees Celsius and different pressures and solute concentrations.

NF filtration experiments were conducted employing a cross-flow filtration arrangement with a feed flow rate set at 2 L/m and a transmembrane pressure of 70 psi. The feedwater temperature was regulated at 25 degrees Celsius using a Fisher Scientific Isotemp 3013™ circulating chiller water bath to ensure consistency. The Sterlitech CF016™ cross-flow filtration cell was utilized, featuring an active membrane surface area measuring 20.6 cm², with a slot depth of 0.23 cm and slot width of 0.39 cm. An RO system was employed to assess the NF membrane performance under high pressure and extended operation, comprising components such as a high-pressure pump (Hydra-cell pump, Wanner Engineering, Inc.™), a 10-liter feed tank, plexiglass and stainless-steel membrane cells, temperature control, data acquisition system, flowmeters, valves, and a back pressure regulator. Membrane samples (5×5 and 5×10 cm²) were placed in the cell, compacted for an hour at a specified pressure and a constant cross-flow rate of 4 LPM, followed by the calculation of water flux by dividing the collected permeate volume over at least 2 hours by the membrane's surface area. The pH of the feed solution was adjusted to 7.5-7.7 using sodium bicarbonate and NaOH. The permeate flow rate was automatically measured for 30 seconds using a computer interface-equipped balance, while the feed water temperature was maintained at 25 degrees Celsius throughout the experiments.

The water flux (J) was determined by the following equation:

$$J = \frac{V}{A Δ t} \qquad ( 1 )$$

where V is the permeate volume (L), A is the effective membrane area (m²), and Δt is the operation time (h).

The solute rejection was calculated as follows:

$$R ( \% ) = ( 1 - ( \frac{{C}_{p}}{{C}_{f}} ) ) \times 100 ) \qquad ( 2 )$$

where Cₚ and C_{f} are the concentrations of solute in the permeate and feed, respectively.

The Mg²⁺/Li⁺ selectivity (S) was also calculated according to the following equation:

$$S = ( \frac{{C}_{Li , p} / {C}_{Mg , p}}{{C}_{Li , f} / {C}_{Mg , f}} ) ) \qquad ( 3 )$$

The conductivity of solutions, including a single salt, was measured by an electrical conductivity meter (AR50, Fisher Scientific) to calculate the rejection. Thermo iCAP6300 Duo (N. America) inductively coupled plasma-optical emission spectrometer (ICP-OES) manufactured by Thermo Fisher Corp. was used to determine the mixed salt concentration in the solutions.

### Example 1: Preparation of Polymer Support Membranes

This example describes the fabrication of support membranes using the NIPS technique along with its different adaptations, which enables tuning the properties and characteristics of the support membranes. In the NIPS process, a polymer solution is prepared by dissolving a polymer and additives in an appropriate solvent. For example, a PSf or PES polymer may be dissolved in one or more solvents so as to form a uniform solution. The solution is then exposed to a nonsolvent, which is a liquid in which the polymer is insoluble. Upon contact with the nonsolvent, phase separation occurs, forming a polymer-rich phase and a nonsolvent-rich phase. This phase separation process is driven by the reduction in solubility of the polymer in the nonsolvent, causing precipitation and aggregation of the polymer chains. Through careful control of parameters such as solvent and additive contents, polymer concentration, and nonsolvent addition rate, the morphology and properties of the resulting membrane can be tailored to meet specific requirements for various applications, including a substrate for making TFC membranes.

Polysulfone (PSf) and PES polymers are favored choices for making support membranes due to their numerous advantages, including excellent membrane formability and flexibility, improved structural durability, and appropriate hydrophobic characteristics conducive to the formation of a thin polyamide layer on the support.

To make the support membrane with NIPS, PSf or PES may be dissolved in the one or more solvents so as to form the uniform solution in s step (i)(a). For example, 14-16% PSf or PES may be dissolved in the one or more solvents to form the uniform solution. The one or more solvents may comprise one or more of N-methyl-2-pyrrolidone, dimethylformamide (DMF), and dimethylacetamide (DMAc). The one or more solvents may comprise dimethylformamide (DMF). Step (i)(a) may be completed under consistent temperature and stirring speeds. For example, dope solutions containing 14-16 wt % of polymers (PES or PSf) were prepared by dissolving in dimethylformamide (DMF) at 60 degrees Celsius under constant stirring at 500 rpm for 4-6 hrs. Additionally, additives may be added to the casting solution in steps (i)(b)-(e), for example such as polyvinylpyrrolidone, polyethyleneglycol, acrylic acid, and surfactant. For example, one or more of 1-5% polyvinylpyrrolidone, 2-10% polyethyleneglycol, 2-10% acrylic acid, and 0.05-5% surfactant may be included in the casting solution. The surfactant may comprise one or more of sodium dodecyl sulfate or Triton X-100 (C₁₄H₂₂O(C₂H₄O)ₙ). The concentration of polyvinylpyrrolidone, polyethyleneglycol, acrylic acid, and surfactant in the uniform solution may be maintained at a constant concentration. For example, the concentration of polyvinylpyrrolidone may be maintained at a range of 1.0-5.0 wt %, a concentration of polyethylene glycol may be maintained at a range of 2.0-10.0 wt %, a concentration of acrylic acid may be maintained at a range of 2.0-10.0 wt %, and a concentration of surfactant may be maintained at a range of 2.0-10.0 wt %. Alternative solvents such as n-dimethylacetamide (DAMc) could also be utilized to prepare polymer solutions. After preparing the homogeneous dope solution the solution may be degassed. For example, in step (i)(f) the solution may be degassed in a vacuum chamber for 5-15 minutes to eliminate air bubbles before casting.

The solution may then be casted to form a cast film in order to complete step (i)(f). The solution may be cast on a suitable nonwoven polyester support at a suitable cast thickness to form a cast film. For example, the solution may be cast on a 100-micron thick nonwoven polyester support at a cast thickness at about 0.10-0.12 mm to form a cast film. The solution may be cast on at a suitable casting speed and may use a semi-automated continuous membrane casting unit to control the casting speed, following the process of NIPS. For example, casting the solution on may be done at a casting speed of 1-2 m/min, using a semi-automated continuous membrane casting unit. The thickness of the cast film was controlled precisely by adjusting the gap between the casting blade and fabric support, maintained within the range of 100-120 μm, and monitored by digital depth micrometers attached at both ends of the casting knife. In a step (1)(g), the cast film may be immersed in a water precipitation bath in order to initiate phase separation. The water precipitation bath may be a suitable temperature, for example, in step (i)(g), the water precipitation bath is at 20-30 degrees Celsius. The cast film was immediately immersed in a water precipitation bath at approximately 30 degrees Celsius to initiate phase separation and left in the bath for 1 hour to ensure the complete removal of solvents and additives from the membrane structure. Following washing, the resulting porous membrane underwent further post-treatment by immersion in a solution, such as glycerol, ethanol, or hexane solutions, either individually, or sequentially, for 10 minutes. In step (i)(h) the one or more solvents may be removed, and the formed support membrane may be treated with a solution. The solution in step (i)(h) may contain one or more of glycerol, ethanol, or hexane, either individually, or sequentially, and the formed support membrane may be treated with the solution for 10-15 minutes. The entire apparatus 10 for producing the support layer of the TFC membrane is illustrated in FIG. 1. The casting machine comprises an unwinding system 18 for releasing the nonwoven fabric, a casting unit 14 for uniform application of the polymeric dope solution onto the polyester substrate, a tank 16 for the gelation bath, guiding rollers 20 positioned appropriately, and a winding system 22 for collecting the fabricated membranes. This system is connected to a motor 24 interfaced with a computer-controlled device capable of maintaining the set speed throughout the process. A representative membrane structure, depicted in FIGS. 2A and 2B, comprises a microporous barrier layer, ideally 1-3 μm in thickness, situated atop a porous support layer, preferably 40-50 μm thick, both constructed from PES polymer. Additionally, a nonwoven material was utilized beneath the membrane layer to enhance mechanical stability and handling of the membrane while minimally impacting its separation performance. The nonwoven support for membrane fabrication exhibits porosity and weight characteristics of approximately 4.2 cfm/ft² and 85 gsm, respectively.

The molecular weight cut-off (MWCO) range for fabricated PES support membranes spans from 10 to 250 kD, preferably within 20 to 100 kD, or more preferably between 70 to 90 kD, with a specific MWCO point of 80 kD. The thickness of the support can vary from 50 to 200 μm, for example, 40 to 50 μm for porous PES support and 90 to 120 μm for polyester nonwoven fabric support. In the case of PES support membranes prepared according to the method outlined in this disclosure, their water permeability ranges from 690 to 917 LMH/bar with pure water as the feed solution, under conditions of 25 degrees Celsius temperature and 2 LPM cross-flow velocity. Table 1 presents the outcomes resulting from different polymer and additive concentrations in the casting solution as described above.

TABLE 1
Support membrane performance and properties (Pure water flux,
HA removal, 100 ppm HA solution, ΔP = 10 psi)

| | Pure water flux | Pure water permeability | HA removal |
|---|---|---|---|
| Membrane | (LMH) | (LMH/bar) | (%) |
| SM-26 | 495 | 728 | 97.1 |
| SM-33 | 535 | 786 | 96.9 |
| SM-44 | 470 | 691 | 94.9 |
| SM-43 | 624 | 917 | 96.0 |

### Example 2: Fabrication TFC Polypiprazine-Amide Membranes

An alternative embodiment of this innovation involves the fabrication of high-efficiency TFC NF membranes designed for lithium extraction. These membranes possess a composite design comprising a thin, smooth selective layer atop a porous support layer, crafted through the method outlined earlier. Specifically, the thin selective layer consists of a polyamide polymer with R1—C(═O)—NH—R2 linkages, synthesized through polymerization involving one or more di- or polyfunctional amines and one or more di- or polyfunctional acyl chlorides. This polymerization process is preferably carried out via IP. The di- or polyfunctional amines may be aromatic, aliphatic, or both. Preferred options for these amines include m-phenylene diamine (MPD) and PIP, while favored choices for di- or polyfunctional acyl chlorides include TMC and isophthaloyl dichloride (IPC). In the IP process, these reactive monomers, a diamine, and a diacid chloride, are dissolved in immiscible solvents and brought into contact at the interface between two phases, usually an organic phase and an aqueous phase. The reaction occurs at the interface between the two phases, where the monomers react to form a thin, dense polymer film. This film grows at the interface and eventually covers the surface of a porous PES support material.

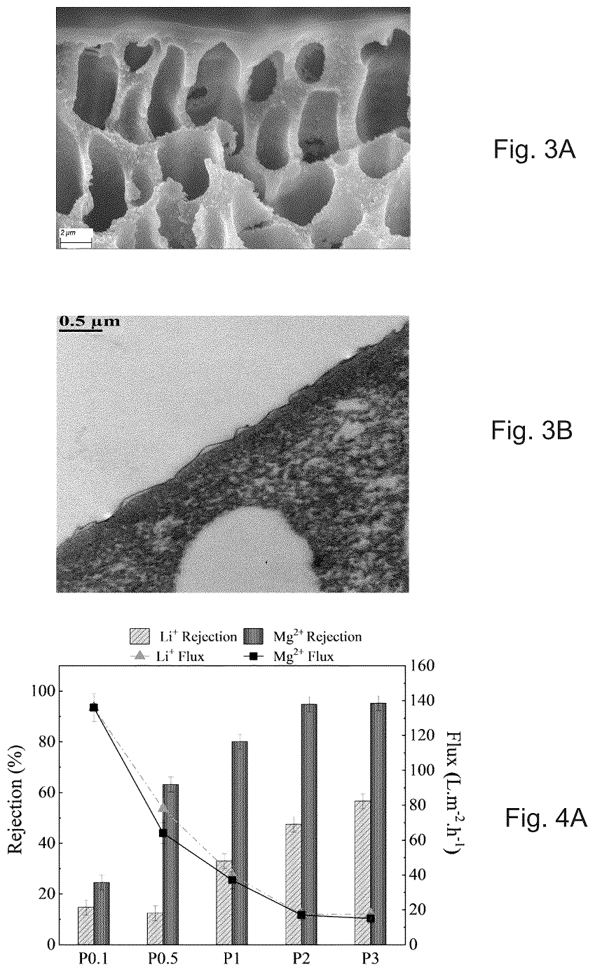

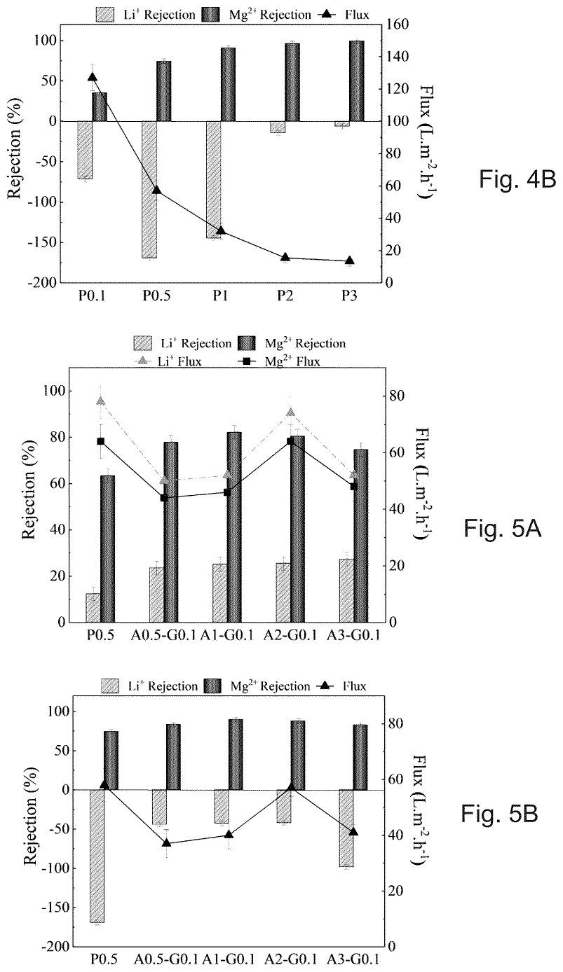

In a step (ii), the formed support membrane may be contacted with an aqueous diamine solution. The aqueous diamine solution may comprise piperazine, and a base such as NaOH. For example, the formed support membrane may be contacted with an aqueous diamine solution comprising 0.1-3% w/v piperazine, and 0.5-2.0% w/v NaOH, for a time period of 60-120 seconds. Aqueous amine solutions may be prepared by dissolving 0.1-3% w/v PIP, 0.5-2.0% w/v NaOH with or without 0.5-2% w/v ARG and L-histidine in water. The aqueous diamine solution may comprise 0.5-2% w/v L-arginine (ARG) and L-histidine. In a step (iii), excess aqueous diamine solution may be removed from the support surface. In a step (iv), an organic solution may be gently poured on the support surface. The organic solution may initiate an interfacial polymerization (IP) reaction. For example, the organic solution may comprise 0.15% w/v TMC and may initiating an interfacial polymerization (IP) reaction. Step (iv) may be carried out over a suitable time period, for example, 30-90 seconds. Organic acid chloride solutions may be prepared by dissolving TMC in hexane. For example, organic acid chloride solutions may be prepared by dissolving 0.05-0.2% w/v TMC in hexane. The resulting aqueous solution may be poured onto the PES substrate and rested for 1-2 minutes, ensuring thorough substrate saturation. In a step (v), the organic solution may be drained from the support surface and membrane (the thin-film composite (TFC) nanofiltration (NF) membrane), The excess solution was subsequently removed by employing a roller to ensure that a very thin layer of amine solution was obtained on the PES support surface. The TMC solutions are then applied on a drained PES surface for a time period of 30-90 sec. Throughout this timeframe, the amine monomer situated on the surface of support initiates a reaction with TMC in hexane at the boundary between the aqueous and organic phases, forming the polypiperazine-amide thin selective layer. The thin-film composite (TFC) nanofiltration (NF) membrane may be heat cured at a suitable temperature for a suitable amount of time. For example, following the IP process, the newly formed TFC membranes underwent heat curing in an oven set at 80° C. for a duration of 5 minutes, without any additional exposure to the atmosphere. In a step (vi), the final thin-film composite (TFC) nanofiltration (NF) membrane may be washed. FIGS. 3A and 3B show an example where the polypiprazine-amide rejection layer is formed on the surface of the support layer. As depicted in FIGS. 3A and 3B, polyamide active layers with a thickness of 50-100 nm were fabricated on the PES porous membrane through in-situ IP of these monomers. This thickness is highly preferred for making highly permeable NF membranes. TFC NF membranes, fabricated using the technique outlined in this disclosure, can yield a flux of 6-10 LMH/bar and exhibit a magnesium ion rejection rate of 85-93% when filtering an aqueous salt solution containing 2000-5000 ppm of MgCl₂ under conditions of 70 psi pressure and 25° C. temperature. The high-performance thin-film composite (TFC) nanofiltration (NF) membrane may be structured to achieve a flux of 6-10 LMH/bar and demonstrate a magnesium ion rejection rate of at least 85% when filtering aqueous salt solutions containing 2000-5000 ppm of MgCl₂ at 70 psi and 25° C., for example a magnesium ion rejection rate of 85-93%. As an example, the effect of PIP concentrations on the separation performance of NF membranes evaluated in the single-salt solutions containing 1000 ppm of LiCl or MgCl₂ is shown in FIG. 4A. with an increase in PIP concentration from 0.1 to 3 wt % in the aqueous solution, Mg²⁺ rejection increased from 24.5 to 95.2%, accompanied by a reduction in water flux from 136 to 15 LMH. A similar trend was observed for Li⁺, with rejection increasing from 14.7 to 56.6%, and water flux decreasing from 136 to 17.5 LMH. Membranes fabricated with a lower PIP concentration formed a loose PA layer with a low crosslinking degree, resulting in high water permeability and poor rejections of both Li⁺ and Mg²⁺. As the PIP concentration increased, the IP reaction intensified, forming a denser PA layer, causing decreased permeability and increased rejections of both Li⁺ and Mg²⁺.

The performances of fabricated membranes with different PIP concentrations were further evaluated in a mixed salt solution with a total concentration of 2000 ppm and Mg²⁺/Li⁺ ratio of 20:1. As illustrated in FIG. 4B, Mg²⁺ rejection during filtration of mixed salt solution (2000 ppm and Mg²⁺/Li⁺ ratio of 20:1) increased from 35.2 to 94.8%, while negative rejections ranging from −6.1 to −169.2% were observed for Li⁺. The high-performance thin-film composite (TFC) nanofiltration (NF) membrane may be structured to filter a mixed salt solution. For example, the high-performance thin-film composite (TFC) nanofiltration (NF) membrane may filter a mixed salt solution (2000 ppm, Mg²⁺/Li⁺ ratio of 20:1) with Mg²⁺ rejection increased substantially from 35.2% to 94.8%, while Li⁺ exhibited negative rejections, ranging from −6.1% to −169.2%. Lithium ion has a lower hydrated diameter (0.764 nm) compared to Mg²⁺ (0.856 nm), facing less steric hindrance to pass through the membrane. In addition, a lower energy barrier of Li⁺ (−515 kJ·mol⁻¹) compared to Mg²⁺ (1828 kJ·mol⁻¹) allows it to easily shed the hydration shell to enter the nanopores. The ion mobility of Li⁺ is also higher than Mg²⁺ due to its more compact structure after partial dehydration. Although the PIP 1 membrane exhibited Li⁺ rejection of −144.7% and Mg²⁺ rejection of 91.0% in the mixed solution, its low water flux of 37 LMH restricts its commercial applications.

### Example 3: Fabrication of Modified TFC Polypiprazine-Amide Membranes

This example describes the procedure for the modification of as-fabricated polypiprazine-amide membranes to improve their retention capability of magnesium ion over lithium ion. Another embodiment of this disclosure is making highly water-permeable TFC NF membranes for industrial applications. An easy-scale-up procedure was developed for the surface modification of TFC NF membranes with chemicals containing amine functional groups such as ARG, L-histidine, and TAP, followed by crosslinking with GLA, which improved the selectivity and efficiency of NF membranes in lithium ion separation. The main mechanism for surface modification of TFC NF membranes with these chemicals involves exposing to a solution containing the amine-functionalized chemicals, enabling their covalent attachment through reaction with the activated sites. This step ensures the immobilization of the molecules onto the membrane surface. Following chemical grafting, treatment with GLA serves to crosslink the surface-modifying molecules, enhancing their stability and preventing leaching or displacement during membrane operation. The reaction between the amine groups of the surface-modifying chemicals and the aldehyde groups of GLA forms stable linkages, effectively creating a robust and durable surface modification layer on the membrane. This mechanism ensures improved membrane performance, including enhanced selectivity, permeability, and fouling resistance. The crosslinked amino acid-modified NF membrane can then be used for selective lithium ion separation, leveraging the enhanced electrostatic interactions between the positively charged membrane surface and lithium ions.

This modification procedure involves several steps: First, solutions containing 0.5-2 wt. % of the chemicals mentioned above (ARG, L-histidine, and TAP) are prepared. In step (vi)(1), after step (vi), a solution may be applied onto the thin-film composite (TFC) nanofiltration (NF) membrane to ensure complete saturation of the membrane. For example, the solution in step (vi)(1) may comprise 0.5-2 wt. % of L-arginine (ARG), L-histidine, and or TAP. The solutions are applied onto the heat-cured TFC NF membrane surface for 2-5 min to ensure complete saturation of the membrane surface. In step (vi)(2), after step (vi)(1), an aqueous solution may be poured onto the surface of L-arginine (ARG), L-histidine, or TAP saturated thin-film composite (TFC) nanofiltration (NF) membrane in order to facilitate crosslinking. For example, the aqueous solution may comprise 0.1-0.5 glutaraldehyde and may be poured onto the surface of L-arginine (ARG), L-histidine, or TAP saturated thin-film composite (TFC) nanofiltration (NF) membrane and the thin-film composite (TFC) nanofiltration (NF) membrane may sit for a sufficient time to facilitate crosslinking. Subsequently, after removing the excess amine-containing solution, the aqueous solutions containing 0.1-0.5 GLA were poured onto the surface of amine-saturated membranes and allowed to sit for 5 minutes to facilitate crosslinking. The GLA reacts with the amino groups of these chemicals, forming stable covalent bonds. This results in the immobilization of ARG, L-histidine, and TAP onto the membrane surface, effectively increasing its positive charge density. In step (vi)(3), after step (vi)(2), the thin-film composite (TFC) nanofiltration (NF) membrane may be heat treated. For example, the coated TFC NF membranes were then heat-treated in an oven at 80 degrees Celsius for 5 minutes.

Finally, the crosslinked membranes were washed with DI water to remove the unreacted chemical from the surface.

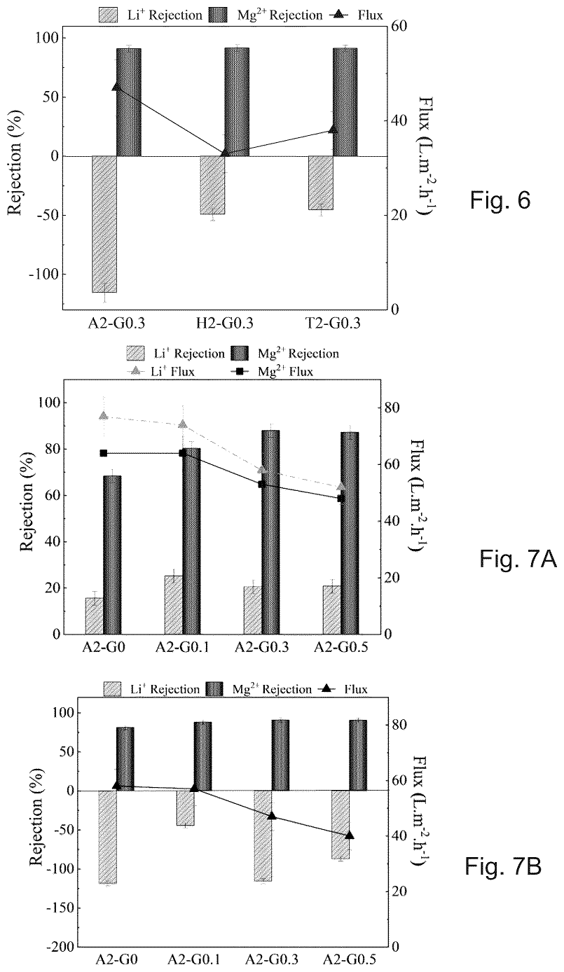

A high-performance thin-film composite (TFC) nanofiltration (NF) membrane may comprise a polysulfone (PSf) or polyethersulfone (PES) support membrane layer and a selective layer. The selective lay may comprises a modified polypiprazine-amide nanofiltration (NF) membrane for separation of lithium from magnesium/lithium and brine solution. As depicted in FIG. 4B, the polypiprazine-amide membrane prepared with 1 wt % of PIP exhibited Li⁺ rejection of −144.7% and Mg²⁺ rejection of 91.0% in the mixed solution of MgCl₂ and LiCl. However, the water permeability of this membrane (37 LMH) is below the average, which restricts industrial applications. Therefore, the NF membrane prepared with 0.5 wt % of PIP with a high-water flux of 64 LMH and a low Mg²⁺ rejection rate of 63.2% was selected for further surface modification to improve the Mg²⁺ rejection. FIGS. 5A and 5B indicates the separation performances of the surface-modified polypiprazine-amide membranes with different concentrations of ARG (0.5-3 wt %) followed by crosslinking with 0.1 wt % GLA aqueous solution. The modified membranes demonstrated a reasonable water flux range (45-70 LMH for single salt solution and 35-57 for mixed salt solution) and considerably improved rejections of both Li⁺ and Mg²⁺ ions compared to the unmodified polypiprazine-amide membrane. The high-performance thin-film composite (TFC) nanofiltration (NF) membrane may be structured to filter a mixed salt solution. For example, the high-performance thin-film composite (TFC) nanofiltration (NF) membrane may be structured to filter a mixed salt solution (2000 ppm, Mg²⁺/Li⁺ ratio of 20:1) and reject at least 88% and −42%, of Mg²⁺ and Li⁺, respectively, with an average flux of at least 45-50 LMH. As an example, the Mg²⁺ and Li⁺ rejections of the optimum modified membrane during filtration of the MgCl₂ and LiCl mixed solution were approximately 88% and −42%, respectively, with an average flux of around 45-50 LMH, while the Mg²⁺ rejection for unmodified membrane were approximately 74% with the average flux of around 55 LMH. As depicted in FIG. 6, The ARG modified membrane demonstrated better performance in terms of water permeability and both Mg²⁺ and Li⁺ rejections compare to L-histidine and TAP modified membranes.

The impact of varying concentrations of GLA, ranging from 0 to 0.5 wt %, on membrane performance was evaluated. As shown in FIGS. 7A and 7B, introducing ARG to the membrane surface without employing GLA did not significantly enhance membrane performance compared to the unmodified NF membrane (PIP-0.5 membrane). This lack of improvement occurred because ARG could not be effectively stabilized on the membrane surface without GLA and was easily washed away. However, increasing the concentration of GLA improved crosslinking, thereby enhancing the positive surface charge of the membrane, and increasing Mg²⁺ rejection. The high-performance thin-film composite (TFC) nanofiltration (NF) membrane may comprise a GLA and ARG. For example, the high-performance thin-film composite (TFC) nanofiltration (NF) membrane may comprise a GLA concentration of 0.3 wt % and a L-arginine (ARG) concentration of 2 wt %. The high-performance thin-film composite (TFC) nanofiltration (NF) membrane may be structured to filter a mixed salt solution (2000 ppm and Mg²⁺/Li⁺ ratio of 20:1, at 70 psi and 25° C.), and reject at least 91.0% of Mg²⁺, and −115.6% of Li⁺, with water flux of at least 47 LMH in the mixed solution. At a GLA concentration of 0.3 wt %, Mg²⁺ rejection reached 91.0%, Li⁺ rejection was −115.6%, and water flux was 47 LMH in the mixed solution. Further increases in GLA concentration did not notably affect rejection rates but reduced water flux to 40 LMH.

### Example 4: Performance Evaluation of Optimized Polypiprazine-Amide Membrane

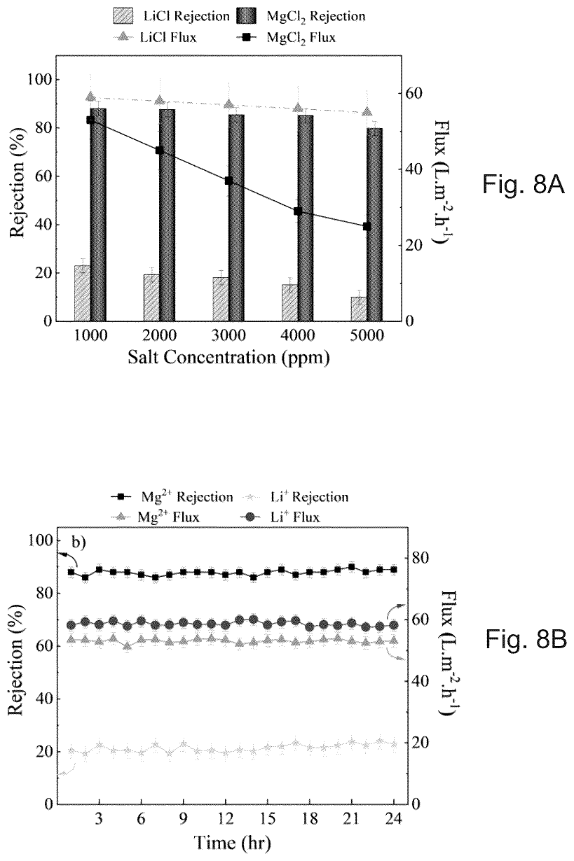

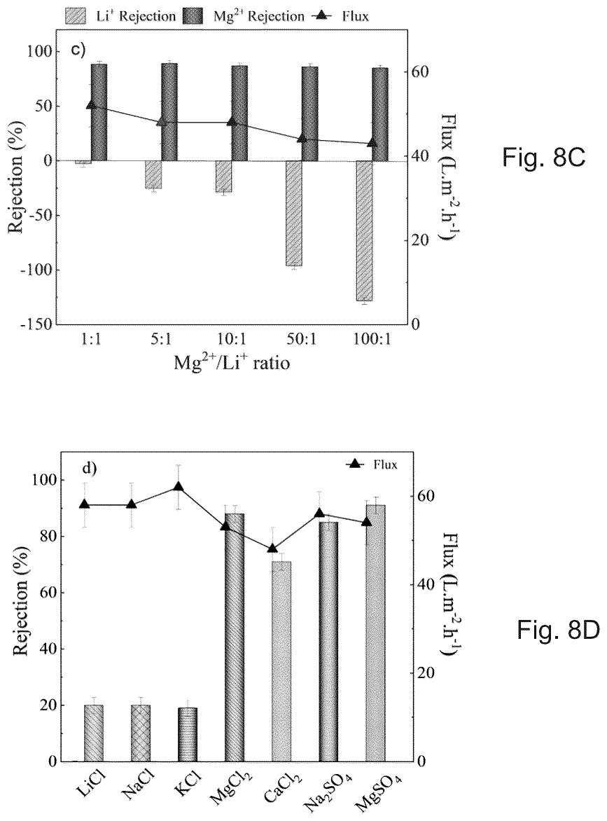

The performance of the optimal membrane, which was modified with 2 wt % ARG and 0.3 wt % GLA, was further explored under varied operational conditions (FIGS. 8A-8D). In FIG. 8A, the impact of salt concentrations on the separation efficacy of the A2-G0.3 membrane is depicted. As the concentration of both LiCl and MgCl₂ salts increased from 1000 to 5000 ppm, the rejection of Li⁺ and Mg²⁺ decreased from 23.0% to 10.1% and 88.0% to 79.8%, respectively, correlating with a decline in water flux from 59 to 55 LMH for lithium salt solution and from 53 to 25 LMH for magnesium salt solution. The rise in osmotic pressure due to higher concentrations resulted in a decrease in water flux. Moreover, a more pronounced decrease in water flux was observed for the feed solution containing MgCl₂ compared to LiCl. This divergence could be attributed to the higher permeability of Li⁺ ions, resulting in a lower osmotic pressure gradient. FIG. 8B illustrates the long-term stability of the A2-G0.3 membrane in dilute solutions. The high-performance thin-film composite (TFC) nanofiltration (NF) membrane may be structured to maintain stable water flux and salt rejection performance over 24 hours of filtration in solutions containing 1000 ppm of LiCl or MgCl₂. The membrane exhibited consistent performance in terms of water flux and salt rejection throughout 24 hours of filtration in solutions containing 1000 ppm of LiCl or MgCl₂.

FIG. 8C depicts the effect of the Mg²⁺/Li⁺ ratio on the performance of the A2-G0.3 membrane, while maintaining a salt concentration in the feed at 2000 ppm. Increasing the Mg²⁺/Li⁺ ratio from 1:1 to 100:1, increased the Mg²⁺/Li⁺ separation factor from 8.8 to 15.0. Although there was a slight decrease in Mg²⁺ rejection from 88.4 to 84.8%, more Li⁺ cations were allowed to pass through the membrane, resulting in a significant change in Li⁺ rejection from −2.8 to −128.3%. Moreover, increasing the Mg²⁺/Li⁺ ratio in the feed resulted in a slight reduction in water flux, decreasing from 52 to 43 LMH due to the increased osmotic pressure associated with higher concentrations of Mg²⁺ in the feed solution.

FIG. 8D illustrates the performance of the A2-G0.3 membrane in filtering various inorganic salts. Single-salt solutions, each containing 1000 ppm of LiCl, NaCl, KCl, MgCl₂, CaCl₂, Na₂SO₄, and MgSO₄, were utilized to evaluate the membrane's performance. When filtering brine (1000 ppm) at 70 psi, the high-performance thin-film composite (TFC) nanofiltration (NF) membrane may be structure to reject at least 20%, 20%, and 19% for the monovalent salts LiCl, NaCl, and KCl, respectively. The A2-G0.3 membrane exhibited low rejections of 20%, 20%, and 19% for the monovalent salts of LiCl, NaCl, and KCl, respectively. The high-performance thin-film composite (TFC) nanofiltration (NF) membrane may be structured to reject at least 88% for MgCl₂, at least 71% for CaCl₂), at least 85% for Na₂SO₄, and at least 91% for MgSO₄. In contrast, it showed higher rejections for divalent cation salts with 88% rejection for MgCl₂ and 71% rejection for CaCl₂. According to the Dannan exclusion theory, the A2-G0.3 membrane, with a more positively charged surface, demonstrated stronger rejection of divalent cations such as Mg²⁺ and Ca²⁺ compared to monovalent cations like Li⁺, Na⁺, and K⁺. Additionally, the hydrated diameter of monovalent cations, including Li⁺ (0.764 nm), Na⁺ (0.716 nm), and K⁺ (0.662 nm), were smaller than Mg²⁺ (0.856 nm) and Ca²⁺ (0.824 nm), resulting in monovalent cations experiencing less steric hindrance to pass through the membrane. The lower rejection of salts containing monovalent cations could also be attributed to their lower dehydration energy compared to divalent cations, facilitating their entry into nanopores. The lower energy barrier of monovalent cations, including Li⁺ (−515 kJ·mol⁻¹), Na⁺ (−364 kJ·mol⁻¹), and K⁺ (−295 kJ·mol⁻¹) compared to divalent cations such as Mg²⁺ (1828 kJ·mol⁻¹) and Ca²⁺ (−1504 kJ·mol⁻¹), allows them to readily shed their hydration shell and pass through the membrane. The A2-G0.3 membrane also showed a higher rejection for MgCl₂ (88%) compared to CaCl₂ (71%), despite both Mg²⁺ and Ca²⁺ cations possessing the same valence. This difference could be attributed to the higher hydrated diameter and dehydration energy of Mg²⁺ compared to Ca²⁺. On the other hand, the A2-G0.3 exhibited high rejections for salts containing divalent anions, with 85% for Na₂SO₄, and 91% for MgSO₄. Additionally, SO₄²⁻ anions need to overcome a higher energy barrier (−1145 kJ·mol⁻¹) to shed their hydration shell to enter the nanopores compared to Cl⁻ (−363 kJ·mol⁻¹). Consequently, a greater quantity of Cl⁻ anions could permeate the membrane, necessitating the passage of more cations to maintain electroneutrality in the permeate. As illustrated in FIG. 8D, a trade-off exists between salt rejection and water flux across different solutions. The high-performance thin-film composite (TFC) nanofiltration (NF) membrane may demonstrate at least water fluxes of 58, 58, and 62 LMH for monovalent cations, such as LiCl, NaCl, and KCl, respectively. Solutions containing monovalent cations such as LiCl, NaCl, and KCl, which exhibited lower rejection, demonstrated higher water flux at 58, 58, and 62 LMH, respectively. The high-performance thin-film composite (TFC) nanofiltration (NF) membrane may demonstrate at least fluxes of 53, 48, 56, and 54 LMH, of MgCl₂, CaCl₂), Na₂SO₄, and MgSO₄, respectively. In contrast, MgCl₂, CaCl₂, Na₂SO₄, and MgSO₄ showed lower water flux at 53, 48, 56, and 54 LMH, respectively. The diminished water permeability in the solution containing CaCl₂ could be attributed to the scaling occurring on the membrane surface.

### Example 5: Performance Evaluation of Optimized Polypiprazine-Amide Membrane with Simulated Brine

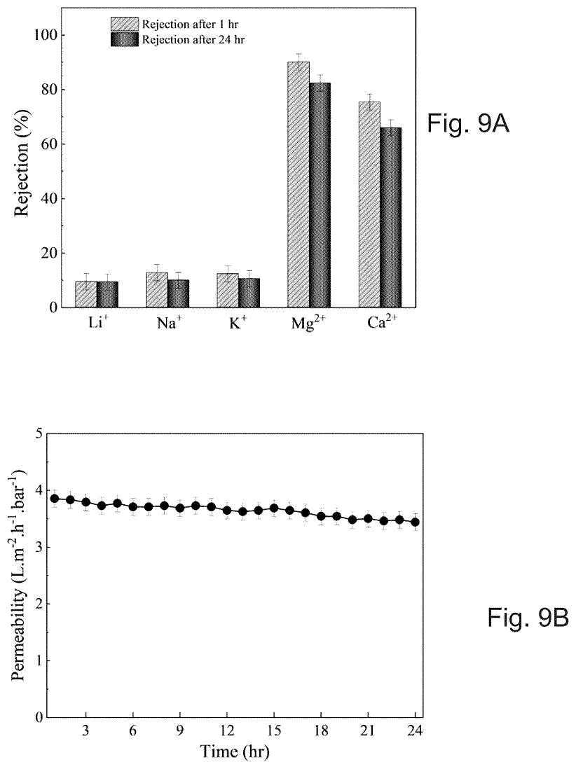

This example provides the performance of the optimized NF membrane during the filtration of two distinct simulated brines to assess the practical applications of these membranes for lithium extraction. The high-performance thin-film composite (TFC) nanofiltration (NF) membrane may be structured to, when filtering brine (21000+ ppm) at 70 psi, demonstrate a water permeability, for example, a water permeability of at least 18.6 LMH. FIGS. 9A and 9B depicts the water permeability and various ion rejections of modified NF membrane during filtration of a simulated brine, including Li⁺, Na⁺, K⁺, Mg²⁺, Cl⁻, and Ca²⁺ ions with a total concentration exceeding 21000 ppm, operated at low pressure of 70 psi. Despite the high TDS value of this simulated brine, the membrane showed a high-water permeability of 18.6 LMH at 70 psi (3.9 LMH/bar. The high-performance thin-film composite (TFC) nanofiltration (NF) membrane may be structured to reject Mg²⁺ (at least 90.1%) and Ca²⁺, for example, at least 75.4%. Additionally, this membrane exhibited significant rejection of magnesium (over 90.1%) and calcium (75.4%) cations. The high-performance thin-film composite (TFC) nanofiltration (NF) membrane may be structured to allow the passage of Li⁺, Na⁺, and K⁺ with rejections of at most 19.5%, 12.8%, and 12.4%, respectively. In contrast, it efficiently allowed the passage of monovalent cations, exhibiting rejections of 9.5% for Li⁺, 12.8% for Na⁺, and 12.4% for K⁺, respectively. The performance stability of this membrane was assessed during 24 hours of filtration (FIG. 9B), showing a slight reduction in water flux and ion rejections. After 24 hours of filtration, the rejections of Li⁺, Na⁺, K⁺, Mg²⁺, and Ca²⁺ cations reached 9.4, 10, 10.6, 82.4, and 66%, respectively, while the water flux was 16.6 LMH. This reduction can be attributed to the gradual salt concentration increment in the feed tank leading to an increase in the fouling tendency and osmotic pressure of the membrane by the substantial number of ions present in the brine.

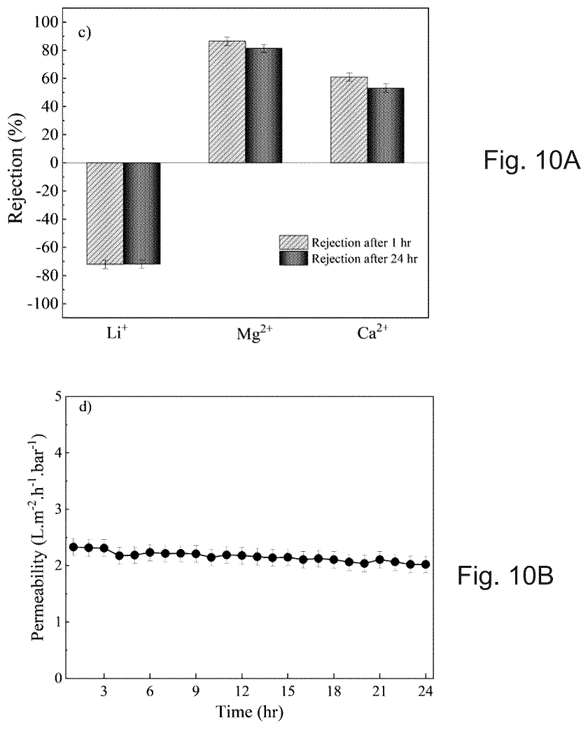

In commercial applications, a multistage pretreatment process is employed to remove interfering ions, such as Na⁺, K⁺, Ca²⁺, SO₄²⁻, boron, and dissolved organic contaminants from brine, ensuring that the resulting output contains acceptable concentrations of Mg²⁺ and Li⁺. Accordingly, the second simulated brine was prepared based on the composition of the pretreated brine sourced from Qinghai, China. When filtering brine (22000 +ppm) at 220 psi and 25° C., the high-performance thin-film composite (TFC) nanofiltration (NF) membrane may be structured to achieve an initial water flux of at least 32.4 LMH, with a decrease of at most to 30.3 LMH after 24 hours, with Li⁺, Mg²⁺, and Ca²⁺ rejections dropping at most from −72.2%, 86.4%, and 60.9% to at least −72.0%, 81.3%, and 53.1%, respectively, over the same period. The second simulated brine includes 5,236 ppm of Mg²⁺, 41 ppm of Ca²⁺, 187 ppm of Li⁺, 510 ppm of SO₄²⁻, and 16,113 ppm of Cl⁻ with a total concentration exceeding 22000 ppm. As illustrated in FIGS. 10A and 10B, the optimized membrane showed an initial water flux of 32.4 LMH at 220 psi and 25 degrees Celsius. However, the water flux slightly decreased within the filtration process and reached 30.3 LMH after 24 hours. In addition, the Li⁺, Mg²⁺, and Ca²⁺ rejections at the beginning of experiments were −72.2%, 86.4%, and 60.9%, which reduced to −72.0%, 81.3%, 53.1% after 24 hr of filtration. In the untreated simulated brine, other monovalent cations, such as Na⁺ and K⁺, competed with Li⁺ cations to pass through the membrane and maintain the neutrality of the permeate side. However, in the treated simulated brine, Li⁺ was the only monovalent cation in the solutions and had a higher chance of permeation.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method of making a high-performance thin-film composite (TFC) nanofiltration (NF) membrane, the method comprising:
(i) preparing a polysulfone (PSf) or polyethersulfone (PES) support membrane by using a non-solvent induced phase separation (NIPS) technique:
(a) dissolving PSf or PES polymer in one or more solvents so as to form a uniform solution;
(b) maintaining a concentration of polyvinylpyrrolidone in the uniform solution at a range of 1.0-5.0 wt %;
(c) maintaining a concentration of polyethylene glycol in the uniform solution at a range of 2.0-10.0 wt %;
(d) maintaining a concentration of acrylic acid in the uniform solution at a range of 2.0-10.0 wt %;
(e) maintaining a concentration of surfactant in the uniform solution at a range of 2.0-10.0 wt %;
(f) degassing the solution, and thereafter casting the solution on a 100-micron thick nonwoven polyester support at a cast thickness at about 0.10-0.12 mm to form a cast film;
(g) immediately immersing the cast film in a water precipitation bath and initiating phase separation;
(h) removing the solvents, and then treating the formed support membrane with a solution;
(ii) contacting the formed support membrane with an aqueous diamine solution comprising 0.1-3% w/v piperazine, and 0.5-2.0% w/v NaOH, for a time period of 60-120 seconds;
(iii) removing excess aqueous diamine solution from the support surface;
(iv) gently pouring an organic solution containing 0.15% w/v TMC on the support surface and initiating an interfacial polymerization (IP) reaction;
(v) draining the organic solution from the support surface and heat-curing the formed thin film composite (TFC) at about 80° C. for about 5 minutes; and
(vi) washing the final thin-film composite (TFC) nanofiltration (NF) membrane.

2. The method of claim 1 in which step (i)(a) comprises dissolving 14-16% PSf or PES in the one or more solvents so as to form the uniform solution.

3. The method of claim in which the one or more solvents comprises one or more of N-methyl-2-pyrrolidone (NMP), dimethylformamide (DMF), and dimethylacetamide (DMAc).

4. The method of claim 1 in which the one or more solvents comprises dimethylformamide (DMF), and step (i)(a) is done at 60° C. under constant stirring at 500 rpm for 4-6 hrs.

5. The method of claim 1 in which in step (i)(e) the surfactant comprises one or more of sodium dodecyl sulfate or Triton X-100 (C₁₄H₂₂O(C₂H₄O)ₙ).

6. The method of claim 1 in which:
in step (i)(c), casting the solution on is done at a casting speed of 1-2 m/min, using a semi-automated continuous membrane casting unit; and
in step (i)(g), the water precipitation bath is at 20-30 degrees Celsius.

7. The method of claim 1 in which the solution in step (i)(h) contains one or more of glycerol, ethanol, or hexane, either individually, or sequentially, for 10-15 minutes.

8. The method of claim 1 in which, in step (ii), the aqueous diamine solution comprises 0.5-2% w/v L-arginine (ARG) and L-histidine.

9. The method of claim 1 in which step (iv) is carried out over 30-90 seconds.

10. The method of claim 1 further comprising, after step (vi):
(vi)(1) applying a solution of 0.5-2 wt. % of L-arginine (ARG), L-histidine, or TAP onto the thin-film composite (TFC) nanofiltration (NF) membrane to ensure complete saturation of the membrane.

11. The method of claim 10 further comprising:
(vi)(2), pouring an aqueous solutions containing 0.1-0.5 glutaraldehyde onto the surface of L-arginine (ARG), L-histidine, or TAP saturated thin-film composite (TFC) nanofiltration (NF) membrane and allowing to sit for a sufficient time to facilitate crosslinking.

12. The method of claim 11 further comprising:
(vi)(3) heat-treating the thin-film composite (TFC) nanofiltration (NF) membrane.

13. A high-performance thin-film composite (TFC) nanofiltration (NF) membrane, comprising:
a polysulfone (PSf) or polyethersulfone (PES) support membrane layer; and
a selective layer that comprises a modified polypiprazine-amide nanofiltration (NF) membrane for separation of lithium from magnesium/lithium and brine solution.

14. The high-performance thin-film composite (TFC) nanofiltration (NF) membrane of claim 12 structured to achieve a flux of 6-10 LMH/bar and demonstrate a magnesium ion rejection rate of at least 85% when filtering aqueous salt solutions containing 2000-5000 ppm of MgCl₂ at 70 psi and 25° C.

15. The high-performance thin-film composite (TFC) nanofiltration (NF) membrane of claim 12 structured to filter a mixed salt solution (2000 ppm, Mg²⁺/Li⁺ ratio of 20:1) with Mg²⁺ rejection increased substantially from 34-36% to 93-95%, while Li⁺ exhibited negative rejections, ranging from −6% to −169%.

16. The high-performance thin-film composite (TFC) nanofiltration (NF) membrane of claim 13 structured to filter a mixed salt solution (2000 ppm, Mg²⁺/Li⁺ ratio of 20:1) and reject at least 88% and −42%, of Mg²⁺ and Li⁺, respectively, with an average flux of at least 45-50 LMH.

17. The high-performance thin-film composite (TFC) nanofiltration (NF) membrane of claim 12, with a GLA concentration of 0.3 wt % and L-arginine (ARG) of 2 wt %, structured to filter a mixed salt solution (2000 ppm and Mg²⁺/Li⁺ ratio of 20:1, at 70 psi and 25° C.), and reject at least 91% of Mg²⁺, and −115% of Li⁺, with water flux of at least 47 LMH in the mixed solution.

18. The high-performance thin-film composite (TFC) nanofiltration (NF) membrane of claim 14 structured to maintain stable water flux and salt rejection performance over 24 hours of filtration in solutions containing 1000 ppm of LiCl or MgCl₂.

19. The high-performance thin-film composite (TFC) nanofiltration (NF) membrane of claim 14 structured to, when filtering brine (1000 ppm) at 70 psi:
achieved rejection rates of at least 20%, 20%, and 19% for the monovalent salts LiCl, NaCl, and KCl, respectively;
achieved rejection rates of at least 88% for MgCl₂, 71% for CaCl₂), 85% for Na₂SO₄, and 91% for MgSO₄;
demonstrate at least water fluxes of 58, 58, and 62 LMH for monovalent cations, such as LiCl, NaCl, and KCl, respectively; and
demonstrate at least fluxes of 53, 48, 56, and 54 LMH, of MgCl₂, CaCl₂), Na₂SO₄, and MgSO₄, respectively.

20. The high-performance thin-film composite (TFC) nanofiltration (NF) membrane of claim 14 structured to, when filtering brine (20000-22000 ppm) at 70 psi:
demonstrate water permeability (at least 18.6 LMH);
reject Mg²⁺ (at least 90%) and Ca²⁺ (at least 75%);
allow the passage of Li⁺, Na⁺, and K⁺ with rejections of approximately 10%, 13%, and 13%, respectively.

21. The high-performance thin-film composite (TFC) nanofiltration (NF) membrane of claim 14 structured to, when filtering brine (21000-23000 ppm) at 220 psi and 25° C.:
achieve an initial water flux of at least 32 LMH, with a slight decrease to 31 LMH after 24 hours, with Li⁺, Mg²⁺, and Ca²⁺ rejections dropping from approximately −73%, 86%, and 60% to approximately −72%, 81%, and 53%, respectively, over the same period.
